(19) United States
(12) Patent Application Publication
(10) Pub. No.: US 2019/0000128 A1
(43) Pub. Date: Jan. 3, 2019

(54) INFANT FORMULA COMPRISING HUMAN MILK PEPTIDES

(71) Applicant: THE A2 MILK COMPANY LIMITED, Auckland (NZ)

(72) Inventors: Andrew John Clarke, Auckland (NZ); Malav Suchin Trivedi, Hollywood, FL (US)

(21) Appl. No.: 16/065,118

(22) PCT Filed: Dec. 21, 2016
(86) PCT No.: PCT/NZ2016/050203

§ 371 Date: Jun. 21, 2018

Related U.S. Application Data
(60) Provisional application No. 62/270,955, filed on Dec. 22, 2015.

(51) Int. Cl. A23L 33/18; A23L 33/19; A23L 33/00

(52) U.S. Cl. CPC A23L 33/18; A23V 2002/00; A23L 33/40; A23L 33/19

(57) ABSTRACT

An infant formula composition containing one or more human beta-casomorphin peptides or precursor proteins thereof.

### TECHNICAL FIELD

The invention relates to infant formula compositions that closely mimic the composition of human breast milk. In particular, the invention relates to infant formula compositions containing human beta-casomorphin peptides derived from beta-casein proteins.

### BACKGROUND OF THE INVENTION

The benefits to infants of breast feeding for at least the first six months of life, and preferably for another 6 to 12 months, are well-established. Human breast milk is known to protect infants from infections and to reduce the rates of health problems including diabetes, obesity and asthma occurring. It is widely accepted that the entire intestinal flora of breast-fed infants provides anti-infective properties and is an important stimulating factor for the postnatal development of the immune system. Breast milk is universally regarded as the best source of nutrition for a new baby. However, it is also well-known that many mothers are not able to breast feed their babies and therefore the use of infant formula (also known as milk formula) to feed babies is the preferred or, in some cases, the only option.

Mature human milk contains 3-5% fat, 0.8-0.9% protein, 6.9-7.2% carbohydrate (calculated as lactose), and 0.2% mineral constituents. The principal human milk proteins are whey and casein. The balance of these proteins allows for quick and easy digestion. The concentration of whey proteins decreases from early lactation and continues to fall. These changes result in a whey/casein ratio of about 90:10 in early lactation, 60:40 in mature milk and 50:50 in late lactation. The principal proteins of human milk are a casein homologous to bovine beta-casein, alpha-lactalbumin, lactoferrin, immunoglobulin IgA, lysozyme, and serum albumin. The essential amino acid pattern of human milk closely resembles that found to be optimal for human infants.

The composition of infant formula is designed to be based on human mother's milk at approximately one to three months postpartum. The most commonly used infant formulae contain purified whey and casein from bovine milk as a protein source, a blend of vegetable oils as a fat source, lactose as a carbohydrate source, a vitamin-mineral mix, and other ingredients depending on the manufacturer. In addition, some infant formulae use soybean as a protein source instead of bovine milk and some infant formulae use protein hydrolysed into its component amino acids for infants who are allergic to other proteins. Besides human breast milk, infant formula is the only other milk product that the medical community considers nutritionally acceptable for infants under the age of one year (as opposed to cow's milk, goat's milk, or follow-on formulae of varied compositions).

Bovine milk typically comprises around 30 grams per litre of protein. Caseins make up the largest component (80%) of that protein, and beta-caseins make up about 37% of the caseins. In the past two decades the body of evidence implicating casein proteins, especially beta-caseins, in a number of health disorders has been growing.

The beta-casein family comprises a number of variants, which are routinely known as A1, A2, A3, B, C, D, E, F, G, H and others. A1 beta-casein and A2 beta-casein are the predominant beta-caseins in milk consumed in most human populations. The applicant and others have previously determined a link between the consumption of A1 beta-casein in milk and milk products and the incidence of certain health conditions including type I diabetes (WO 1996/014577), coronary heart disease (WO 1996/036239) and neurological disorders (WO 2002/019832). Further, the applicant has shown a link between A1 beta-casein and bowel inflammation (WO 2014/193248), lactose intolerance (WO 2015/005804), and high blood glucose levels (WO 2015/026245).

A1 beta-casein differs from A2 beta-casein by a single amino acid. A histidine amino acid is located at position 67 of the 209 amino acid sequence of A1 beta-casein, whereas a proline is located at the same position of A2 beta-casein. This single amino acid difference is, however, critically important to the enzymatic digestion of beta-caseins in the gut. The presence of histidine at position 67 allows a protein fragment comprising seven amino acids, known as beta-casomorphin-7 (BCM-7), to be produced on enzymatic digestion. Thus, BCM-7 is a digestion product of A1 beta-casein. In the case of A2 beta-casein, position 67 is occupied by a proline which hinders cleavage of the amino acid bond at that location. BCM-7 is not a digestion product of A2 beta-casein.

All beta-caseins can be categorised as A1 type or A2 type based on whether the beta-casein has a proline or histidine at position 67. Thus, the A1 type of beta-caseins includes A1, B, C, G and H beta-caseins whereas the A2 type of beta-caseins includes A2, A3, D, E and F beta-caseins. The A1 type beta-caseins are therefore able to produce BCM-7 on digestion. The A2 type beta-caseins are not able to produce BCM-7.

Beta-casomorphins (BCMs) are biologically active opioid peptides derived from beta-casein. Protease enzymes present in milk are known to liberate BCMs from beta-caseins prior to ingestion and during digestion. BCMs vary in length of peptide chain, for example BCM-4 comprises four amino acids whereas BCM-7 comprises seven amino acids. All BCMs appear to have opioid activity, but with different affinities. Generally, the shorter the BCM, the stronger the affinity for opioid receptors. Bovine BCMs are structurally similar, but not identical, to human BCMs. For example, bovine and human BCM-7 differ by two amino acids at positions 4 and 5 of the peptide. These structural differences affect the opioid activity of BCM-7. Bovine BCMs have been shown to be at least 10 times more potent (i.e. have greater binding affinity to mu-opioid receptors) than human BCMs.

The applicant has now found that human BCM-7 (hBCM-7) exhibits preferential neurogenic effects compared to bovine BCM-7 (bBCM-7) and thus has a positive effect on brain growth and development relative to bBCM-7. It is anticipated that infant formula containing human BCMs, and/or peptide precursors to human BCMs, will therefore be beneficial to the health and development of infants.

The invention is therefore based on the incorporation into infant formula compositions of peptides found in human breast milk. These peptides are preferably, although not limited to, hBCM-5, hBCM-7 and peptides that are precursors of hBCM-5 and hBCM-7. The associated benefits include brain growth and development and improved immune system development.

It is therefore an object of the invention to provide an infant formula composition containing one or more human beta-casomorphins, or their biological precursors, or to at least provide a useful alternative to existing compositions.

### SUMMARY OF THE INVENTION

In a first aspect of the invention there is provided an infant formula composition containing one or more human beta-casomorphin peptides or precursor peptides thereof. The one or more human beta-casomorphin peptides may be any of BCM-4 to BCM-24, but are preferably BCM-5 and/or BCM 7.

In a second aspect there is provided a method for preparing an infant formula composition including the step of adding to an ingredient mixture one or more human beta-casomorphin peptides.

In another aspect there is provided the use of an infant formula composition of the invention as a food for an infant.

In another aspect there is provided the use of one or more human beta-casomorphin peptides or precursor peptides thereof in the preparation of an infant formula composition.

### BRIEF DESCRIPTION OF THE FIGURES

FIG. 1 shows partial amino acid sequences of bovine A1 beta-casein, bovine A2 beta-casein and human beta-casein.

FIG. 2 shows Venn diagrams A and B depicting the contrasting pattern of gene expression (DETs) and gene promoter methylation levels (DMTs) between human BCM-7 (hBCM-7) and bovine BCM-7 (bBCM-7).

FIG. 3A is an image of magnified foetal stem cells treated with a saline control showing extensive neuronal differentiation.

FIG. 3B is an image of magnified foetal stem cells treated with 1 μM morphine showing extensive neuronal proliferation.

FIG. 3C is an image of magnified foetal stem cells treated with 1 μM hBCM-7 showing higher neuronal differentiation compared to bBCM-7.

FIG. 3D is an image of magnified foetal stem cells treated with 1 μM bBCM-7 showing less neuronal differentiation compared to hBCM-7.

FIG. 4 shows GSH:GSSG ratios for hBCM-7, bCM-7 and bBCM-9.

FIG. 5 shows SAM/SAH ratios for hBCM-7, bCM-7 and bBCM-9.

FIG. 6 shows CpG methylation levels for hBCM-7, bCM-7 and bBCM-9.

### DETAILED DESCRIPTION

The invention relates to infant formula compositions containing human beta-casomorphins (BCMs), especially BCM-5, BCM-7 and/or precursor peptides.

The term “beta-casomorphin” means any peptide derived from the digestion of the milk protein beta-casein.

The term “infant formula” means a manufactured food designed for feeding to babies and infants under 12 months of age, usually prepared for bottle-feeding or cup-feeding from powder (mixed with water) or liquid (with or without additional water). The U.S. Federal Food, Drug, and Cosmetic Act (FFDCA) defines infant formula as “a food which purports to be or is represented for special dietary use solely as a food for infants by reason of its simulation of human milk or its suitability as a complete or partial substitute for human milk”. Infant formula is designed to be roughly based on a human mother's milk at approximately one to three months postpartum. The most commonly used infant formulas contain purified cow's milk whey and casein as a protein source, a blend of vegetable oils as a fat source, lactose as a carbohydrate source, a vitamin-mineral mix, and other ingredients depending on the manufacturer.

The term “precursor peptide” means any peptide that can be digested or otherwise transformed or broken down into another peptide or is a structural analogue of another peptide. Typically, the amino acid chain of a precursor peptide is cleaved at one or more locations to produce a peptide having fewer amino acid residues. For example, BCM-9 and BCM-11 are precursor peptides for BCM-5. A “structural analogue” of a particular peptide includes any peptide or peptidomimetic having the same biological function as the particular peptide although a different structure to the particular peptide.

The term “milk powder”, also referred to as “powdered milk” or “dried milk”, means milk that has been evaporated to dryness and has been formed as a powder or processed to form a powder.

As described above, the bovine beta-caseins can be categorised as A1 beta-casein and A2 beta-casein. These two proteins are the predominant beta-caseins in milk consumed in most human populations. A1 beta-casein differs from A2 beta-casein by a single amino acid. A histidine amino acid is located at position 67 of the 209 amino acid sequence of A1 beta-casein, whereas a proline is located at the same position of A2 beta-casein. This single amino acid difference is, however, critically important to the enzymatic digestion of beta-caseins in the gut. The presence of histidine at position 67 allows a protein fragment comprising seven amino acids, known as beta-casomorphin-7 (BCM-7), to be produced on enzymatic digestion. Thus, BCM-7 is a digestion product of A1 beta-casein. In the case of A2 beta-casein, position 67 is occupied by a proline which hinders cleavage of the amino acid bond at that location. Thus, BCM-7 is not a digestion product of A2 beta-casein.

Other beta-casein variants, such as B beta-casein and C beta-casein, also have histidine at position 67, and other variants, such as A3, D and E, have proline at position 67. But these variants are found only in very low levels, or not found at all, in milk from cows of European origin. Thus, in the context of this invention, the term “A1 beta-casein” refers to any beta-casein having histidine at position 67, and the term “A2 beta-casein” refers to any beta-casein having proline at position 67.

BCM-5 and BCM-7 are considered to be the more important of the BCMs. They have the highest affinity for opiate receptors and consequently are the most studied of the BCM peptides. The presence of BCM-5 and BCM-7 in human breast milk has been investigated (Jarmolowska et al., Peptides, 2007, 28, 1982-1986). A significantly higher concentration of both BCM-5 (five times higher) and BCM-7 (eight times higher) was found in colostrum than in mature milk. The amount of BCM-5 present in human breast milk was found to range from about 5 μg/L (colostrum) to about 0.5 μg/L (four months) and for BCM-7, from about 3 μg/L (colostrum) to about 0.3 μg/L (four months). In colostrum, BCM-5 and BCM-7 were found to be present in a ratio of approximately 1.6:1, in milk collected one month from delivery approximately 2.5:1, and in milk collected four months from delivery approximately 1.7:1. Because BCMs are proline-rich, they are highly resistant to attack by most proteases. This means that BCMs can reach the intestine in unchanged form and affect the gut mucosa. The immaturity of the gut mucosa and immune system in the first 12 postnatal days means that gut permeability to biomolecules during this time is high. The high levels of BCM-5 and BCM-7 in colostrum indicates that they may affect not only the gastrointestinal tract but also the whole organism after passing through the gut barrier and entering the systemic circulation.

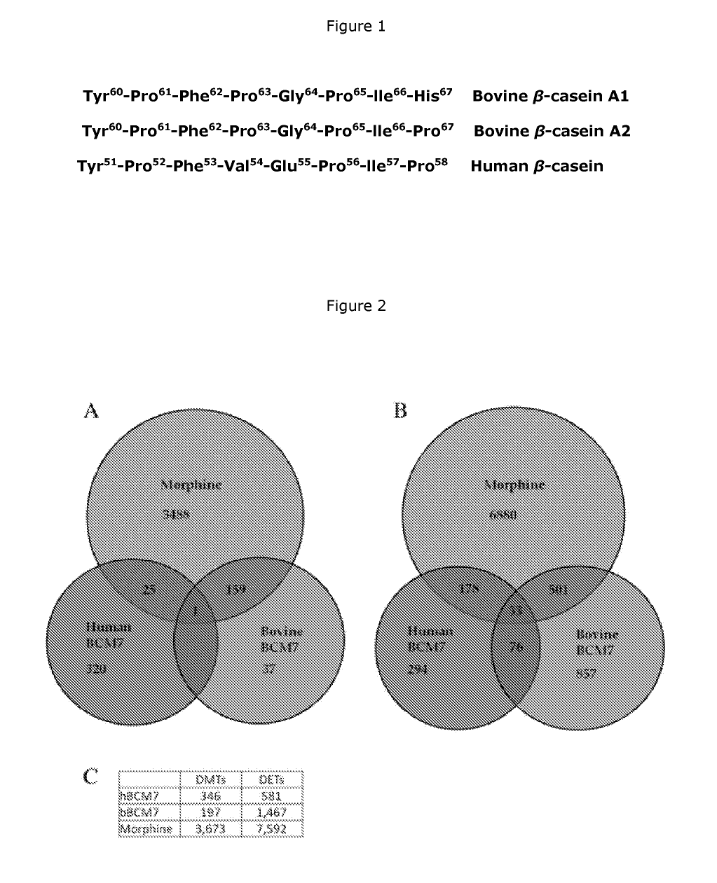

As can be seen from FIG. 1, human beta-casein is not the same as either bovine A1 beta-casein or A2 beta-casein. More specifically, the sequence encoding BCM-7 is different between the species. Thus, these peptides have a differential effect.

The applicant has investigated functional differences between bovine BCMs and human BCMs and found that certain human BCMs have potentially important beneficial characteristics relative to their bovine counterparts. The outcomes of the investigations have important implications for the manufacture of infant formula, in particular the use of human BCMs in infant formula for gut development, brain growth and development, and immune system development in infants.

The invention therefore provides an infant formula composition containing one or more human beta-casomorphin peptides or precursor peptides thereof. The one or more human beta-casomorphin peptides may be any of BCM-4 to BCM-24 (i.e. any one of BCM-4, BCM-5, BCM-6, BCM-7, BCM-8, BCM-9, BCM-10, BCM-11, BCM-12, BCM-13, BCM-14, BCM-15, BCM-16, BCM-17, BCM-18, BCM-19, BCM-20, BCM-21, BCM-22, BCM-23, and BCM-24), but are preferably BCM-5 and/or BCM 7. Precursor peptides may be selected from the group comprising structural analogues of any one of BCM-4, BCM-5, BCM-6, BCM-7, BCM-8, BCM-9, BCM-10, BCM-11, BCM-12, BCM-13, BCM-14, BCM-15, BCM-16, BCM-17, BCM-18, BCM-19, BCM-20, BCM-21, BCM-22, BCM-23, and BCM-24.

In some embodiments of the invention the composition further includes beta-casein derived from bovine milk wherein the total beta-casein content of the milk comprises at least 50% w/w A2 beta-casein, preferably at least 90% w/w A2 beta-casein, for example at least 91%, at least 95%, at least 98%, at least 99%, or even 100% w/w A2 beta-casein.

While it is preferred that the beta-casein variant is A2 beta-casein, it should be understood that the A2 beta-casein may be any A2 type beta-casein variant, i.e. any of A2, A3, D, E and F beta-caseins which have proline at position 67 of the beta-casein amino acid sequence. In some embodiments of the invention the bovine milk is obtained from bovine cows that are known to have the beta-casein A2A2 genotype.

Milk comprising beta-casein that is predominantly or exclusively A2 beta-casein (i.e. contains little or no A1 beta-casein) may be obtained by firstly genotyping cows for the beta-casein gene, identifying those cows that have the ability to produce A2 beta-casein in their milk and no other beta-casein (i.e. cows having the A2A2 allele), and milking those cows. The methodology is described generally in WO 1996/036239 and will be appreciated and understood by those skilled in the fields of animal genotyping, herd formation and the production and supply of bovine milk.

The human BCMs to be incorporated into the infant formula of the invention may be prepared by any known standard technique. These techniques include chemical synthesis, recombinant DNA techniques, and isolation of peptides from human breast milk.

As shown in Example 1, despite both being both generalised as exorphins, bBCM-7 and hBCM-7 have contrasting effects on patterns of short and long term gene expression.

The applicant investigated genome-wide epigenetic changes under the influence of hBCM-7 and bBCM-7. To investigate functional pathway and gene network changes induced by these two peptides and morphine, DNA methylation MBD-seq and DNA microarray data were collected. Control SH-SY5Y neuroblastoma cells and cells treated for 4 h with 1 μM hBCM-7, bBCM-7 or morphine were investigated. Morphine served as a positive opioid effect control.

Whole genome DNA MBD-seq revealed differentially methylated promoter transcripts (DMTs), as defined by FDR<0.1. Microarray data revealed differentially expressed transcripts (DETs), defined by fold change ≥1.5 and raw p-value 5≤0.05, which included differentially methylated/transcribed genes from both genic and non-coding regions.

The Venn diagrams in FIG. 2 show overlap and contrast in pattern of DETs and DMTs in SH-SY5Y human neuroblastoma cells that were treated with 1 μM morphine, bBCM-7 or hBCM-7 for 4 h (n=5). Gene expression was analysed by genome-wide microarray to generate lists of DETs (Diagram A). DNA methylation was analysed by MBD-seq to yield lists of DMTs (Diagram B). DMTs and DETs were plotted to illustrate overlapping transcript changes caused by one or more of the treatment groups compared with non-treated control. For DETs, N=3; fold change≥1.5; raw p≤0.05. For DMTs, N=5, FDR<0.1.

Example 2 shows contrasting effects of hBCM-7 and bBCM-7 on neuronal stem cell (NSC) growth and differentiation, with bBCM-7 being more comparable to the morphine control and hBCM-7 showing higher levels of cellular differentiation. Administration of hBCM-7 promoted NSC neurogenesis to a greater extent than did administration of the other opioid peptides tested, including bBCM-7. This effect was most apparent when hBCM-7 was administered for 1 d starting on 3 dpp (days post-plating).

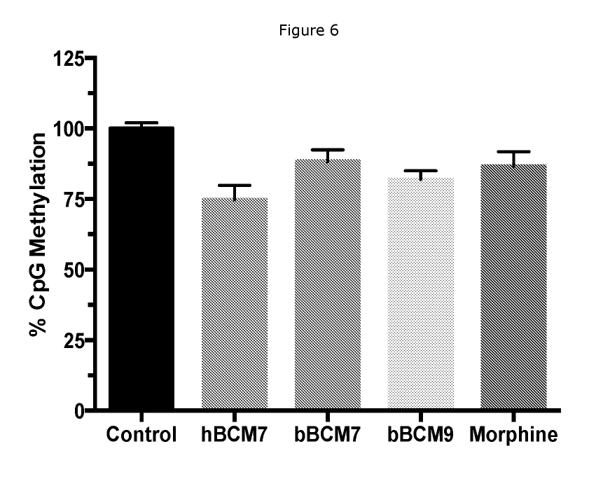

Example 3 shows the effect of opioid peptides (morphine, bBCM-7, hBCM-7, and bBCM-9) on the intracellular thiol levels (GSG:GSSH ratios) of differentiating NSCs at 3 dpp. It was found that the administration of bBCM-7 or morphine significantly increased the GSH/GSSG ratio (FIG. 4) and significantly decreased the SAM/SAH ratio (FIG. 5). In contrast, neither of these ratios was affected by hBCM-7 or bBCM-9. All four peptides tended to decrease CpG methylation compared with the levels in control cells, with hBCM-7 being comparable to bBCM-9 and markedly different from both controls and bBCM-7 (FIG. 6). Redox status, as well as the intracellular levels of antioxidants such as GSH and methylation capacity in the form of donor SAM levels, are important contributors to the process of NSC differentiation.

The functional similarities between hBCM-7 and bBCM-9 (which is derived from A2 beta-casein) are a strong indicator that, not only are human BCMs beneficial as an ingredient in infant formula compositions, the milk powder base of the composition should preferably be derived from milk that has A2 beta-casein (or any A2 type of beta-casein) as its principle or sole beta-casein component. Milk powder derived from milk that contains an appreciable amount of A1 beta-casein (or any A1 type of beta-casein) should be avoided.

Although the mechanisms underlying the differential effects of hBCM-7 and bBCM-7 are unclear, it is possible that bBCM-7 has a stronger agonistic activity toward μ opiate receptors expressed on NSCs, causing greater changes in the redox and methylation states. These differential effects might also contribute to the health benefits of breast feeding relative to formula feeding in early infancy.

The infant formula composition of the invention may be prepared using any known manufacturing process. The one or more human BCM peptides or precursor peptides thereof may be added at any suitable stage in the process.

Powdered infant formula may be manufactured by any standard method, typically using a dry blending process or a wet mixing/spray drying process. In the dry blending process, the ingredients are in a dehydrated powdered form and are mixed together to achieve a uniform blend of the macro and micro nutrients necessary for a complete infant formula product. The blended product is then passed through a sifter to remove oversize particles and extraneous material. The sifted product is then transferred to bags, totes or lined fibreboard drums for storage. In some cases, the powder is transferred directly to the powder packaging line. At the packaging line, the powder is transferred to a filler hopper that feeds powder into the can filling line. Filled cans are flushed with inert gas, seamed, labelled, coded and packed into cartons.

In the wet blending/spray drying process, the ingredients are blended together, homogenised, pasteurised and spray dried to produce the powdered product. The ingredients are blended with water in large batches then pumped to a heat exchanger for pasteurisation. The liquid is usually homogenised and any heat sensitive micronutrients (e.g., vitamins, amino acids and fatty acids) are added. The liquid may be concentrated by passing it through an evaporator or it may be pumped directly to a spray dryer. After spray drying, the product may be agglomerated to increase the particle size and to improve its solubility. In an alternative process, the milk can be dried by drum drying where milk is applied as a thin film to the surface of a heated drum. The milk solids can then be scraped off. Freeze drying may also be used. The drying method and the heat treatment of the milk as it is processed alters the properties of the milk powder, such as its solubility in cold water, its flavour and its bulk density. The finished powder is passed through a sifter then transferred to bags, totes or silos for storage, or transferred directly to the powder packaging line.

Any reference to prior art documents in this specification is not to be considered an admission that such prior art is widely known or forms part of the common general knowledge in the field.

As used in this specification, the words “comprises”, “comprising”, and similar words, are not to be interpreted in an exclusive or exhaustive sense. In other words, they are intended to mean “including, but not limited to”.

The invention is further described with reference to the following examples. It will be appreciated that the invention as claimed is not intended to be limited in any way by these examples.

### EXAMPLES

### Example 1: Contrasting Effects of hBCM-7 v. bBCM-7 on Short and Long Term Gene Expression.

### Materials

Morphine was obtained from Sigma Chemicals (Catalog# M8777, St. Louis, Mo.). Human and bovine forms of BCM-7 were custom synthesised by Neopeptide (Cambridge, Mass.). SH-SY5Y human neuroblastoma cells were purchased from ATCC® (Manassas, Va.).

Cells were grown as proliferative monolayers in 10 cm standard tissue culture dishes, containing 10 mL of alpha-modified Minimum Essential Medium (a-MEM) from Mediatech (Manassas, Va.) supplemented with 1% penicillin-streptomycin-fungizone, also from Mediatech, and 10% fetal bovine serum (FBS) from HyClone (Logan, Utah) at 37 ° C. with 5% CO₂. Cells (Passage#4) treated for 4 h with 1 μM hBCM-7, bBCM-7, morphine or left untreated as a control prior to RNA or DNA extraction. This concentration was chosen on the basis of previous dose-response studies indicating that 1 μM produced maximum inhibition of EAAT3-mediated cysteine uptake.

DNA from cell culture for the analysis of DNA methylation was isolated using the FitAmp™ Blood & Cultured Cell DNA Extraction Kit from Epigentek (Farmingdale, N.Y.). Isolated DNA was quantified using a ND-1000 NanoDrop (Wilmington, Del.) spectrophotometer. RNA from cell culture for the analysis of RNA transcription was isolated using the RNAqueous®-4PCR kit from Ambion (Austin, Tex.). Isolated RNA was treated with DNase, followed by RNA quantification using a ND-1000 NanoDrop spectrophotometer. Genomic DNA was extracted from samples with the Easy DNA kit (Invitrogen K1800-01; Grand Island, N.Y.) using the appropriate protocol for cell lines.

DNA methylation measurement was performed using the MethylCap-Seq protocol (De Meyer et al., PLoS ONE. 2013;8, e59068). EdgeR (Robinson et al., Bioinforma Oxf. Engl. 2010;26:139-40) was used for the detection of regions with differential MBD coverage between conditions.

For microarray hybridizations, 500 ng of total RNA from each sample was labelled with fluorescent dye (Cy3; Amersham Biosciences Corp, Piscataway, N.J.) using the Low RNA Input Linear Amplification Labeling kit (Agilent Technologies, Palo Alto, Calif.) following the manufacturer's protocol. The amount and quality of the fluorescently labelled cRNA was assessed using a NanoDrop ND-1000 spectrophotometer and an Agilent Bioanalyzer. According to manufacturer's specifications, 1.6 mg of Cy3-labeled cRNA was hybridised to the Agilent Human Whole Genome Oligo Microarray (Agilent Technologies, Inc., Palo Alto, Calif.) for 17 h, prior to washing and scanning. Data was extracted from scanned images using Feature Extraction Software (Agilent Technologies, Inc., Palo Alto, Calif.).

Pairwise comparisons (e.g. hBCM-7 [4 h] v. bBCM-7 [4 h]) were carried out using Student's t-test (at a fold change ≥1.5, raw p≤0.05) to generate lists of differentially expressed genes.

Statistical analyses were carried out using Graph Pad Prism® version 5.01. Student's t-test for independent means was used to test for significant differences between untreated control and experimental groups. Data were expressed as mean±standard error of the mean (SEM). Comparisons between multiple groups of data were conducted using one-way analysis of variance (ANOVA) followed by Tukey's post-hoc test to determine the differences between individual groups.

### Method

SH-SY5Y neuroblastoma cells were treated with 1 μM hBCM-7 and bBCM-7. RNA and DNA were isolated after 4 h with or without treatment. Transcriptional changes (DETs) reflecting short term changes in gene expression were assessed using a microarray approach and long term effects to gene expression where obtained through CpG methylation (DMTs) status was analysed at 450,000 CpG sites. Functional implications from both endpoints were evaluated via Ingenuity Pathway Analysis 4.0, and KEGG pathway analysis was performed to identify biological interactions between transcripts that were significantly altered at DNA methylation or transcriptional levels (p<0.05, FDR<0.1). The results are shown in FIG. 2.

### Example 2: Contrasting Effects of hBCM-7 and bBCM-7 on Foetal Stem Cell Neurogenesis

### Neuronal Stem Cell Cultures

Previously isolated and frozen neuronal stem cell cultures were properly thawed, maintained and cultured. Cell suspensions were grown in a defined medium (DF12) composed of DMEM/F12 (1:1), 2 mM L-glutamine, 1 mM sodium pyruvate, antibiotics/antimycotics (Invitrogen, Grand Island, N.Y.), 0.6% glucose, 25 μg/ml insulin, 20 nM progesterone, 60 μM putrescine, 30 nM sodium selenite (all from Sigma, St. Louis, Mo.), 100 μg/ml human transferrin (Roche, Indianapolis, Ind.), 20 ng/ml human recombinant endothelial growth factor (EGF; Roche or Invitrogen, Chicago, Ill.) and basic fibroblast growth factor (bFGF; Upstate Biotechnology, Lake Placid, N.Y.). The cells grew as free-floating aggregates (neurospheres) and were passaged by mechanical dissociation every 3-4 d. After a minimum of four passages, the cells were plated at a density of 18,000 cells/cm² on eight-well glass slide chambers (Nalge Nunc International, Naperville, Ill.) coated with 15 μg/ml poly-L-Iysine (Sigma). Cultures were maintained in DF12 and EGF or EGF plus bFGF for 3 d and then switched to DF12 without growth factors for longer culture periods. Immunocytochemical studies were performed at different time points between 3 and 10 dpp. To analyze the effects of opioid peptides, the cells were treated with 10 μM concentrations of morphine, human hBCM-7, bovine bBCM-7, and bBCM-9 (American Peptide, Sunnyvale, Calif.). Peptides were reconstituted in sterile water and incubated at 37° C. for 1 d or 3 d. Parallel wells were maintained in DF12 without the test peptides (untreated group). Immunocytochemical analyses were performed at 1, 3, or 10 d after treatment.

### Indirect Immunocytochemistry

Cells were fixed with 4% paraformaldehyde for 20 min, permeabilised with an ethanol-acetic acid solution (19:1) at 20° C. for 20 min, blocked with 10% fetal bovine serum, and incubated with primary antibodies overnight at 4° C. Sister cultures served as negative controls and were similarly processed, except for incubation without the primary antibody in each case. Immunofluorescence was used for detection of all antigens. Monoclonal anti-nestin (clone Rat 401; 1:200) was obtained from the Developmental Studies Hybridoma Bank (University of Iowa, Iowa City, Iowa). Polyclonal anti-glial fibrillary acid protein (1:500) was purchased from Dakopatts (Glostrup, Denmark). Monoclonal anti-β tubulin isotype III (1:2000) and polyclonal anti-β tubulin isotype III (1: 2000) were purchased from Covance (Richmond, Calif.). Polyclonal anti-01 (1:5) was obtained from a hybridoma purchased from American Type Culture Collection (Manassas, Va.). Monoclonal anti-bromodeoxyuridine (BrdU; 1:50) was obtained from Dako (High Wycombe, UK), and monoclonal anti-neuronal nuclei (NeuN) was obtained from Chemicon (Temecula, Calif.). For single labelling of neural antigens, goat anti-mouse IgG (H+L) or goat anti-rabbit IgG (H+L) labeled with AlexaFluor 568 or AlexaFluor 488 were purchased from Molecular Probes (Eugene, Oreg.).

### Assessment of Cell Proliferation and Apoptosis

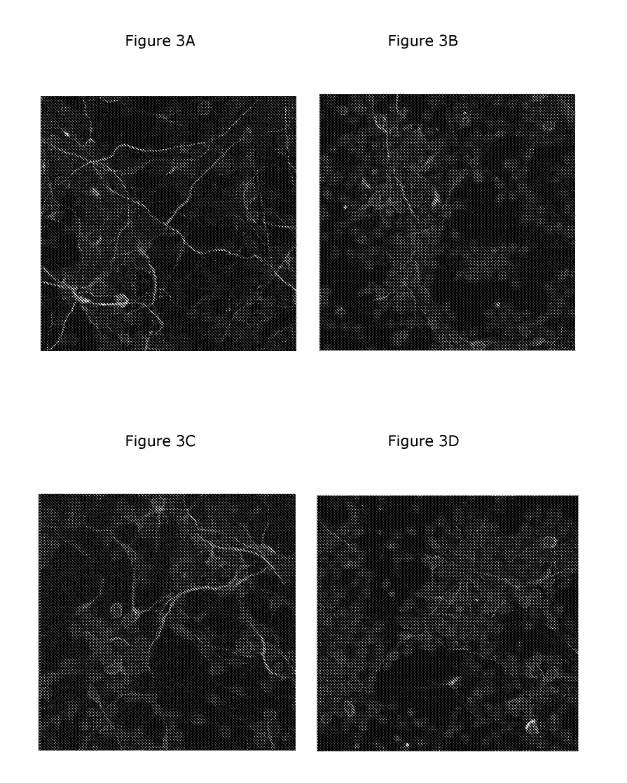

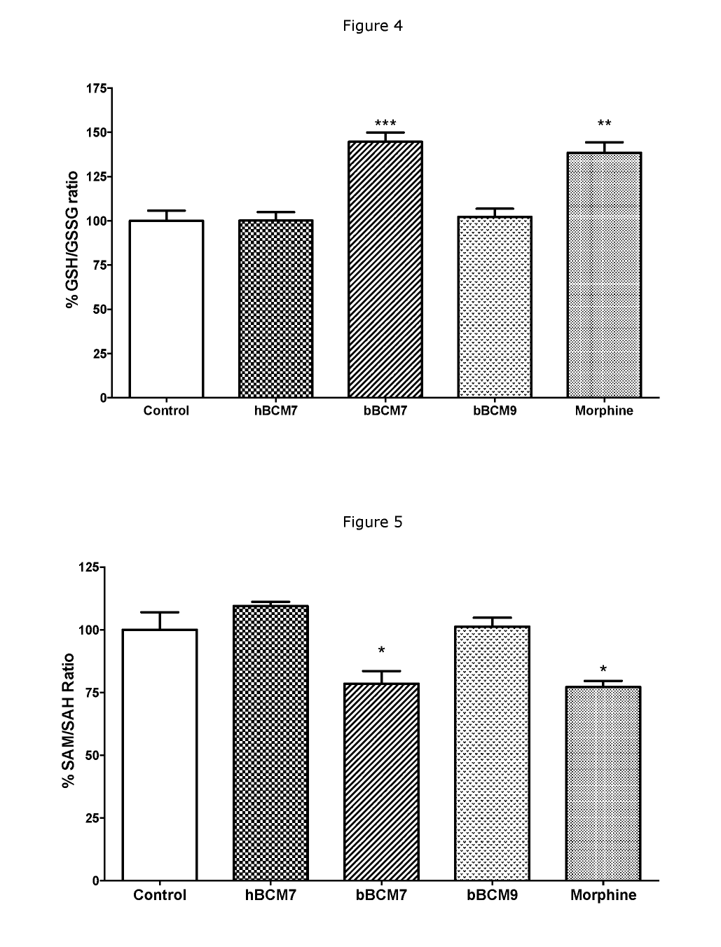

To identify proliferating cells, 100 μM BrdU, an analog of thymidine, was added 24 h before cell fixation. After permeabilisation with ethanol acetic solution (19:1), cells were treated with 2N HCl for 30 min at 4° C. to denature DNA. A primary monoclonal antibody against BrdU (1:20; Dakopatts) was added for 1 h at room temperature and detected using AlexaFluor 488-labelled goat anti-mouse IgG (H+L). This method allowed identification of cells that had duplicated their DNA in the last 24 h. Apoptotic cells were visualised with Hoechst 33342 (LifeTechnologies, Md.) as fragmented pycnotic blue-stained nuclei and counted under the fluorescence microscope (López-Toledano M.A. and Shelanski M.L., 2004 Neurogenic effect of beta-amyloid peptide in the development of neural stem cells. J Neurosci. 24(23):5439-44). The results are shown in FIGS. 3A to 3D.

### Example 3: Comparative Effect on Cell Response Shown Between hBCM-7 and A2 Beta Casein Derived bBCM-9, as Demonstrated by Cell GSH:GSSH Ratios, and DNA Methylation Activity Reflected in Enzyme Activity and Methylation

### Isolation of Intracellular Thiol Metabolites

Neuronal stem cell cultures were grown to confluence in stem cell-specific growth media as described in Example 2, and were then incubated with the indicated drugs for specific times. The medium was aspirated and the cells were washed twice with 1 mL of ice-cold HBSS. The HBSS was then aspirated and 0.6 mL of ice-cold dH₂O was added to the cells and the cells scraped from the flask/dish. The cell suspension was sonicated for 15 s on ice and 100 μL of the sonicate was used to determine protein content. The remaining lysate was added to a microcentrifuge tube with an equal volume of 0.4 N perchloric acid, and incubated on ice for 5 min. Samples were centrifuged at 10,000 g and the supernatant was transferred to new microcentrifuge tubes. Then, 100 μL of the sample was added to a conical microautosampler vial and kept at 4° C. in the autosampler cooling tray. Finally, 10 μL of this sample was injected into a high-performance liquid chromatography (HPLC) system.

### HPLC Measurement of Intracellular Thiols

Concentrations of the following metabolites were measured: cysteine (CYS), cystine (CYS2), glutathione (GSH), glutathione disulfide (GSSG), homocysteine (HCY), homocystine

(HCY2), methionine (MET), S-adenosyl homocysteine (SAH), and S-adenosyl methionine (SAM). The redox and methylation pathway metabolites were separated using an Agilent Eclipse XDB-C8 analytical column (3×150 mm; 3.5 μm) and an Agilent Eclipse XDB-C8 (4.6×12.5 mm; 5 μm) guard column. Two mobile phases were used. Mobile phase A comprised 0% acetonitrile, 25 mM sodium phosphate, 1.4 mM 1-octanesulfonic acid, adjusted to pH 2.65 with phosphoric acid. Mobile phase B was 50% acetonitrile. The flow rate was initially set at 0.6 mL/min and a step gradient was used, as follows: 0-9 min 0% B, 9-19 min 50% B, 19-30 min 50% B. The column was then equilibrated with 5% B for 12 min before the next run. The column temperature was maintained at 27° C. The electrochemical detector was an ESA CoulArray with BDD Analytical Cell Model 5040 and the operating potential was set at 1500 mV. Sample concentrations were determined from the peak area for each metabolite using standard calibration curves and ESA software, and then normalised for protein concentration. Some samples were diluted in the mobile phase, as needed, or up to 50 μl of sample was injected to ensure the thiol concentration was within the range of the standard curve.

### Isolation of Genomic DNA

Genomic DNA was isolated from cultured cells to measure global DNA methylation. DNA was isolated from harvested cells using FitAmp Blood & Cultured Cell DNA Extraction Kits (Epigentek, Farmingdale, N.Y.). The isolated DNA was cleaned for any contaminating RNA by treatment with RNAase enzyme and quantified using ND-1000 NanoDrop spectrophotometer (Thermo Scientific).

### Measurement of Global DNA Methylation

Global DNA methylation analysis was performed using MethylFlash Methylated DNA Quantification Kits according to the manufacturer's instructions (Epigentek). Briefly, 100 ng of clean genomic DNA was used and DNA methylation was quantified using 5-methylcytosine monoclonal antibodies in an enzyme-linked immunosorbent assay-like reaction. The levels of methylated DNA were calculated based on the optical density of each well on a microplate reader at 450 nm. Results were normalised against a standard curve prepared using the kit's methylated standards ranging from 0% to 100%.

### Data Analysis

Results are expressed as the mean±standard error of the mean of direct counts of positive cells for each antibody from independent experiments done in triplicate or quadruplicate. Where indicated, the data were normalised relative to the relevant control group. In each culture, 25 predetermined visual fields were counted under a confocal microscope. The number of positive cells was corrected for the total number of cells in the same area, with Hoechst nuclear staining. Statistical analyses were performed using analysis of variance with the Bonferroni post hoc test or Student's t test as appropriate. Differences were considered significant at P<0.05. All statistical analyses were conducted using Prism 6.0 software (Graph-Pad Software, San Diego, Calif.). The results are shown in FIGS. 4 to 6.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

1. An infant formula composition containing one or more human beta-casomorphin peptides or precursor peptides thereof.

2. A composition as claimed in claim 1, wherein the one or more human beta-casomorphin peptides are selected from the group comprising BCM-4, BCM-5, BCM-6, BCM-7, BCM-8, BCM-9, BCM-10, BCM-11, BCM-12, BCM-13, BCM-14, BCM-15, BCM-16, BCM-17, BCM-18, BCM-19, BCM-20, BCM-21, BCM-22, BCM-23, and BCM-24.

3. A composition as claimed in claim 1 or claim 2, wherein the one or more human beta-casomorphin peptides are selected from BCM-5 and BCM-7.

4. A composition as claimed in any one of claims 1 to 3, comprising both BCM-5 and BCM-7.

5. A composition as claimed in any one of claims 1 to 4, wherein the one or more human beta-casomorphin peptides or precursor peptides thereof are selected from the group comprising structural analogues of any one of BCM-4, BCM-5, BCM-6, BCM-7, BCM-8, BCM-9, BCM-10, BCM-11, BCM-12, BCM-13, BCM-14, BCM-15, BCM-16, BCM-17, BCM-18, BCM-19, BCM-20, BCM-21, BCM-22, BCM-23, and BCM-24.

6. A composition as claimed in any one of claims 1 to 5, further including beta-casein derived from bovine milk wherein the total beta-casein content of the milk comprises at least 50% w/w A2 beta-casein.

7. A composition as claims in claim 6, wherein the total beta-casein content of the milk comprises at least 90% w/w A2 beta-casein.

8. A composition as claimed in claim 6 or claim 7, wherein the A2 beta-casein is any beta-casein having proline at position 67 of the beta-casein amino acid sequence.

9. A composition as claimed in any one of claims 6 to 8, wherein the bovine milk is obtained from bovine cows that are known to have the beta-casein A2A2 genotype.

10. A composition as claimed in any one of claims 1 to 9, wherein the one or more human beta-casomorphin peptides are prepared by chemical synthesis.

11. A composition as claimed in any one of claims 1 to 9, wherein the one or more human beta-casomorphin peptides are prepared using a recombinant DNA technique.

12. A method for preparing an infant formula composition including the step of adding to an ingredient mixture one or more human beta-casomorphin peptides.

13. A method as claimed in claim 12, wherein the one or more human beta-casomorphin peptides are selected from the group comprising BCM-4, BCM-5, BCM-6, BCM-7, BCM-8, BCM-9, BCM-10, BCM-11, BCM-12, BCM-13, BCM-14, BCM-15, BCM-16, BCM-17, BCM-18, BCM-19, BCM-20, BCM-21, BCM-22, BCM-23, and BCM-24.

14. A method as claimed in claim 12 or claim 13, wherein the one or more human beta-casomorphin peptides are selected from BCM-5 and BCM-7.

15. The use of a composition as claimed in any one of claims 1 to 11 as a food for an infant.

16. The use of one or more human beta-casomorphin peptides or precursor peptides thereof in the preparation of an infant formula composition.
